(19) United States
(12) Patent Application Publication
(10) Pub. No.: US 2005/0025151 A1
(43) Pub. Date: Feb. 3, 2005

(54) Early-processing request for an active router

(75) Inventors: Olivier Marce, Massy (FR); Laurent Clevy, Chartres (FR); Olivier Le Moigne, Ottawa (CA)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/774,501

(22) Filed: Feb. 10, 2004

(30) Foreign Application Priority Data
Feb. 11, 2003 (FR) 03 01 587

(51) Int. Cl. H04L 12/56

(52) U.S. Cl. 370/392; 370/400

(57) ABSTRACT

The operating process for an active node (1) of a packet-switched communication network, and in particular of an active IP router, includes the following successive steps:
a) receipt of an active packet sent by a terminal (2); b) execution of a request contained in the active packet, this request being intended to configure packet processing functions; c) and then execution of a program contained or identified in the active packet, this program being intended to control packet processing functions.

The active packet can also be sent by the router to a recipient terminal (3). The invention also proposes an active node, in particular an IP router, implementing the process. The invention also proposes a data packet which includes a request and a program or an identifier for a program, the request and the program being intended for execution by an active node.

The invention concerns the processing of data packets transmitted in a communication network, and more particularly the processing of packets in an active router.

The technique of transmitting packets from a sender to a recipient in a packet-switched communication network, by transiting through intermediate nodes, is already known. In the particular case of a network using the IP protocol (i.e. the Internet Protocol), these nodes are generally known as routers.

For convenience, we will use the term “router” only, even though the description applies more generally to the nodes of packet-switched communication networks.

Such a network can include routers of the active type. An active router has the capacity to be programmed in order to perform special processes on the data packets passing though it, or to change its behaviour dynamically.

To program an active router, a packet is sent to it containing an address of the network in which the programme or the code to be executed by the router is available. The router then downloads the program from this address in its memory and executes it. Optionally, the program can be included in the packet which has been addressed to it, in which case the router loads the program into its memory by reading it from this packet.

Since such a packet serves to supply the router with the address of the program or the program itself, it is called an “active packet” in the remainder of the description.

An active packet can also include data which are intended for any appliance on the network other than the active router, in which case the packet conventionally contains the address of the recipient appliance.

The program loaded by the active router is generally specific to a stream of packets which are passing through the active router after programming of the router with this program. In what follows, this stream of packets will be referred to as the stream to be processed. Thus, the active router is used to perform special processing on the packets in the stream to be processed, using the program that it executes. The processing performed by the router can, for example, consist of transcoding a stream of video data packets on IP from one format to another by a single program instance. The active router is capable of recognising the packets belonging to the active stream, using a filter which is included in the program. Document FR 2.827.726 describes such an active node.

Nevertheless, these systems from the earlier technologies hove some drawbacks. In particular, it can happen that the router has not yet loaded and launched the execution of the program contained or identified in the active packet when packets in the stream to be processed arrive at the router. As a consequence, these packets are sent to their recipient even though the intended processing has not been applied to them by the router.

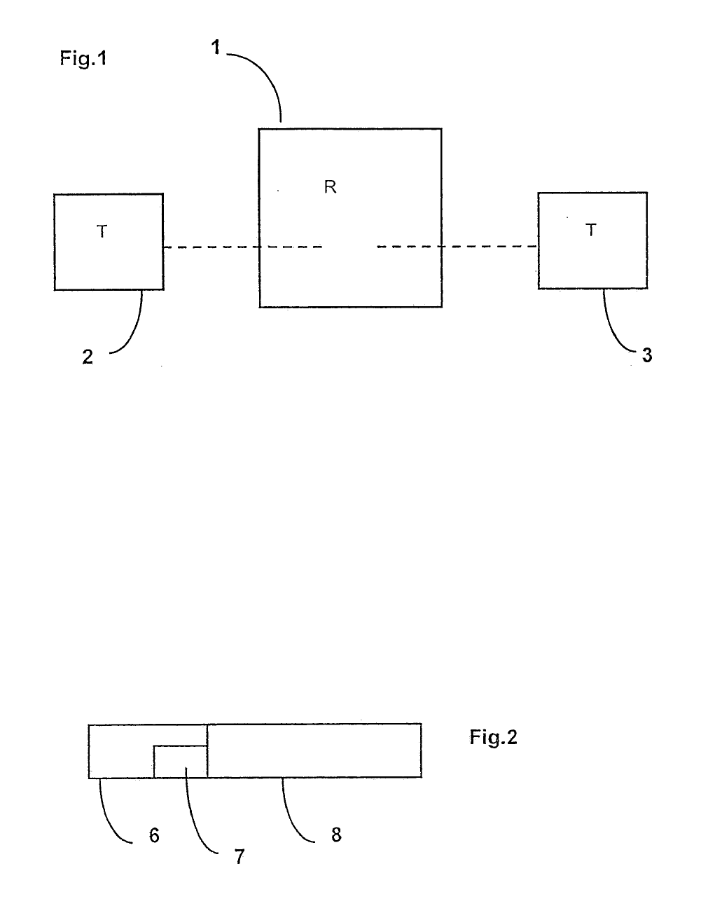

We are going to illustrate a typical example of a situation in which this drawback can emerge, in relation to FIG. 1. A first terminal (2) sends an active packet via the network to a second terminal (3). This active packet contains a message intended for terminal 3, in order to ask it to send a video stream on IP to terminal 2, for example. In addition, this active packet contains the identifier of a program available on the network and used to process the packets of the video stream that terminal 3 will sent to terminal 2, this program having to be downloaded and executed by an intermediate router (1) between terminals 2 and 3.

When it receives the active packet, the router (1) reads the network at which the program to be downloaded is located. Then it sends the packet to terminal 3, since the router (1) has no processing to do on the active packet. In addition, the router (1) begins the downloading of said program from its network address. In response to the active packet, terminal 3 sends the requested video stream to terminal 2, this stream passing via the router (1).

It can happen that the first packets of the video stream are received by the router (1) without the latter running the program. It may be that the router (1) is still in the process of downloading the program when it receives the first packets of the video stream. In these conditions, the router (1) simply sends these packets to terminal 2 without performing the processing planned for these packets. In the worst case, the stream to be processed can have fully passed through the router (1) before the router has run the program, in which case the whole of the stream to be processed avoids all processing.

In another example, terminal 2 sends an active packet via the network to terminal 3. This active packet, for example, contains information to indicate to terminal 3 that it is going to send it a video stream on IP, for example. In addition, this active packet contains the identifier of a program available on the network and used to process the packets of the video stream that terminal (2) is going to send to terminal 3. This program has to be downloaded and executed by an intermediate router (1) between 2 and 3.

When it receives the active packet, the router (1) reads the network address at which the program to be downloaded is located. Then it sends the packet to terminal 3 since the router (1) has no processing to effect on the active packet. In addition, the router (1) begins the downloading of said program from its network address. In response to the active packet, terminal 3 sends a message via the network to terminal 2 to inform it that it is ready to receive the video stream. On receipt of this message, terminal 2 sends the video stream to terminal 3. Here again, it can happen that the first packets of the video stream are received by the router (1) without the latter running the program, or that it is still in the process of downloading the program. And again, the router (1) simply sends all or part of the packets to terminal 3 without effecting the planned processing.

One solution consists of configuring the router to always block the active packet that it receives as long as the program has not been loaded or run. But this solution has the disadvantage of slowing the exchanges between the terminals of the network and can even be unacceptable in certain applications. This is particularly the case for an application of the real-time type which requires that the packets should be routed with the minimum of delay, or indeed with a constant delay. If the first packet or packets are blocked during the loading of the program, then the routing of the packets will not be homogenous in terms of delay.

The aim of the invention is to overcome, at least partly, the drawbacks of the earlier technologies by proposing a technology which allies reliability and flexibility.

Thus, the invention proposes an operating process for an active node which is liable to be processing data packets by executing a program contained or identified in an active packet, this program being intended to control functions for the processing of data packets, characterised in that it includes the following steps:
a) receipt of an active packet;
b) execution of a request contained in the active packet, and intended to configure packet processing functions;
c) execution of a program contained or identified in the active packet, and intended to control data packet processing functions, this program being executed after the execution of this request.

According to one preferred embodiment, step b) includes the putting in place of a packet filter. In this embodiment, step b can be followed with advantage by a step for reception and storage of packets corresponding to the filter, for at least as long as step c has not been executed.

In another preferred embodiment, said active packet should be sent to a network address and after step b), the process includes a step for sending of the active packet to said address.

According to yet another preferred embodiment, said active packet should be sent to a network address, and the process includes a step for sending the active packet to said address either after step b), or after step c), depending on the request contained in the active packet.

According to yet another preferred embodiment, step b) includes an operation for the dimensioning of a packet storage queue.

According to yet another preferred embodiment, step b) includes an operation for reading parameters from the active pocket, for running the program.

According to a particularly advantageous embodiment, step c) includes an operation for the downloading of a program identified in the active packet.

According to another aspect, the invention proposes an active node, in particular an IP router, suitable for the processing of data pockets by executing a program contained or identified in an active packet, this program being intended to control data packet processing functions, characterised in that it includes the means for:
a) receipt of an active pocket;
b) execution of a request contained in the active packet, and intended to configure packet processing functions;
c) and execution of a program contained or identified in the active packet, and intended to control data packet processing functions, this program being run after the execution of this request.

According to yet another aspect, the invention proposes a data packet, charocterised in that it includes:
a request intended to be executed in an active node, in order to configure pocket processing functions, before the execution of a program controlling pocket processing functions;
and a program, or the identifier of a program, where this program is intended to be executed in an active node in order to control packet processing functions, after the execution of the request.

According to one preferred embodiment, the data packet is of the IP type, and the program or said program identifier, as well as said request, are placed in the options of the IP packet.

In the context of the invention, the request contained in the packet gives rise to the processing of packets by the active router, where this processing is capable of being of any type other than a conventional routing operation.

The invention is now described in greater detail in the description which follows, and with reference to the drawings, in which:

FIG. (1) shows, schematically, two terminals and one active router in an IP network in which the process is implemented;

FIG. (2) shows an example of the IP packet structure.

The invention concerns an active packet identifying or containing a program to be loaded into the memory of an active router and to be executed by the latter. The packet preferably contains an identifier for the program to be downloaded via the network, since frequently the program is too long to be contained in the active packet itself. According to the invention, the active packet also contains at least one request. When the active router receives such an active packet, it reads this request from the active packet and executes it immediately, before running the program, and even before downloading the program or in parallel with the downloading process.

This has the advantage of allowing the request to be implemented without having to wait for the running of the program, which may possibly take a long time, especially if it is downloaded via the network. The request can thus allow early processing before the running of the program, for the purpose of ensuring, for example, the reliable functioning of the program.

In particular, the request can be used for the putting in place of a filter as a result of which the router intercepts the packets from the stream to be processed and places them in a temporary storage queue even before the running of the program. After being loaded and run by the router, the program performs the intended processing on the packets thus intercepted, and then sends them to the recipient.

We are now going to illustrate a preferred example with reference to FIG. (1).

A first terminal (2) sends an active packet via the network to a second terminal (3). This active packet contains a message intended for terminal 3 in order to ask it to send a video stream on IP to terminal 2 for example.

This active packet also contains an identifier for a processing program available on the network, and used to process the packets of the video stream which terminal 3 will send to terminal 2, This program has to be downloaded and executed by an intermediate router (1) between terminals 2 and 3. Although FIG. 1 shows only a single intermediate router between terminals 1 and 2, it is obviously possible that there can be a multiplicity of routers, either active or not, between these two terminals.

As an example, the processing performed by the program includes transcoding of the video data of the video stream in one format to another format, for adaptation to the display format of terminal 2 for example. Said program identifier can include, for example, the name of the program to be downloaded and the network address at which it is available. Optionally, the packet can contain the program itself, at least when its size allows it to be placed in the packet.

Finally, the active pocket also contains at least one request intended to be executed by the active router (1) in an anticipated fashion in relation to the execution of the program to be downloaded. These requests will henceforth be referred to as “early-processing requests”.

FIG. (2) details the structure of the active packet. Part 6 is the IP header which includes part 7 corresponding to the IP options. Part 8 represents the body of the pocket (also known as the “payload”). It is preferable that the early-processing request or requests, as well as the identifier of the processing program (or the processing program itself) should be placed in port 7, corresponding to the IP options. The use of the IP options is particularly appropriate, since this zone of the IP pocket is intended to carry information on the processing to be effected on the pocket. The existing routers are generally designed to be capable of processing the information contained in the IP options. The message intended for terminal 3 con be placed conventionally in part 8 of the active packet.

An early-processing request can take the form of coded information contained at a special predetermined location in the active packet, the active routers being programmed to be able to interpret this coded information in order to implement the corresponding requests. Optionally, an early-processing request con also be a program or code to be executed (other than a program for processing of the packets by the active routers). In this case also, the early-processing request can be recognisable because of the special predetermined location in the active packet.

Furthermore, the identifier of the processing program (or the processing program itself) can also be placed at a special predetermined location in the active pocket (other than that reserved for the early-processing requests). Thus, the router easily recognises the processing program or its identifier as such, and avoids any confusion with the early-processing request or requests.

There is another particularly advantageous way to allow the routers to recognise the presence of one or more early-processing requests in the active packet, as well as the identifier of the processing program (or the processing program itself). It is based on the marking of the, or of each, early-processing request, as well as of the identifier of the processing program (or the program itself) by means of a label which takes a different value according to the nature of the marked element, that is according to whether it is an early-processing request or the identifier of the processing program (or the program itself).

In particular, the label can be followed immediately by the request or the identifier of the program (or the program itself) that it is used to mark in the pocket. In this case, the label can also include the length of the element that it is marking (the request, the identifier of the program, or the program itself, as appropriate). Thus, the early-processing request or requests and the identifier of the program (or the program itself) accompanied by their respective labels, can come one after the other in the packet. In addition, the first label can always be placed at a predetermined position in the packet. Thus, on receipt of the active packet, the router reads the first label at this predetermined position. From the information supplied by the first label, the router knows both the nature and the length of the element that it is marking, and it uses this not only to read and handle this first element in a suitable manner, but also to determine the position of the next label. In this way, the router can successively read and handle all of the marked elements—early-processing requests and processing program identifier (or processing program)—by means of the labels.

The use of labels is advantageous because of its flexibility for management of the locations reserved for the early-processing requests and for the identifier of the processing program (or the program itself) in the active packet. This solution is particularly suitable in the case of packets of the IP type.

Of course, other ways to identify the early-processing requests, and the processing program within the active packet, can also be employed.

The active packet includes an appropriate indication which allows the active router (1) to recognise that this packet is of the active type. In particular, this indication can be of the type used in the earlier technologies. As an example, one option is the inclusion of a marker in its header. More particularly, for this it is possible to specify a reserved option of the IP packet. According to another example, the “Flow Label” field of the Ipv6 protocol, is used to mark the packet as active. In particular, it is possible to give a predetermined value to such a field of the packet, in order to indicate that it is an active packet. According to yet another example, a marker of an MPLS label of the packet can be used to indicate that the packet is active. The use of a marker included in an MPLS label allows the active router to determine more quickly whether or not the packet is active.

When it receives the active packet, the router (1) identifies it as such because of the above-mentioned indication present in the packet. The router then checks for the presence of one or more early-processing requests in the active packet. In the affirmative, it reads the latter and executes it. Furthermore, the router (1) reads the program or the identifier of the program to be downloaded from the active packet.

It then sends the active packet to terminal 3, since the router (1) has no processing to do on the active packet. It is preferable that the router (1) sends the active packet to terminal 3 only after it has executed the early-processing requests.

As a preferred example, an early-processing request can include the definition of a filter to be put in place by the router, where the filter allows the router to identify the packets belonging to the stream to be processed by the program. In particular, the filter can be implemented in accordance with parameters contained in the packets in the stream to be processed, such as:
the address of the recipient of the stream to be processed (terminal 2 in our example); or
the address of the sender of the stream to be processed (terminal 3 in our example); or
an identifier placed in part of the data (the payload) of the packets in the stream to be processed; or
the source or destination ports, or
the identification of the protocol used to format the data zone of the packets in the stream to be processed.

The router (1) therefore puts the filter in place before transmitting the active packet to terminal 3. Furthermore, the router (1) begins downloading said program from its network address. In response to the active packet, terminal 3 sends the requested video stream to terminal 2, this stream passing via the router (1).

When the packets of the video stream arrive at the router (1), it recognises them using the filter already in place. As a result, the router (1) places these packets in a temporary storage queue while waiting for them to be processed by the program. On receipt of these packets, it is possible that the router (1) has not yet run the program. It is even possible that the router (1) is still in the process of downloading the program. Once the program has been downloaded and run, the router (1), by application of the program, processes the packets that it previously stored in the queue, and then sends the processed packets to terminal 2. Thus, none of the packets in the stream to be processed is transmitted to terminal 2 without having been actually processed by the router (1 ).

Optionally, in the example described previously in relation to FIG. 1, terminal 2 sends an active packet via the network to terminal 3, this active packet containing information indicating to terminal 3 that it is going to send a video stream on IP for example. The active packet also contains an identifier for a program available on the network and used to process the packets of the video stream that terminal 2 is going to sent to terminal 3, This program has to be downloaded and executed by an intermediate router (1) between terminals 2 and 3. Finally, the active packet also contains at least one early-processing request as before.

As previously, when it receives the active packet, the router (1) identifies it as such, checks for the presence of early-processing requests in the active packet and execute s them where appropriate. Furthermore, the router (1) reads the program or the identifier of the program to be downloaded in the active packet. It then sends the active packet to terminal 3 after executing the early-processing requests. As previously, an early-processing request can include the definition of a filter for identification of the packets in the stream to be processed. In response to the active packet, terminal 3 sends a message via the network to terminal 2, to inform it that it is ready to receive the video stream. On receipt of this message, terminal 2 sends the video stream to terminal 3.

Here again, it can happen that the first packets of the video stream are received by the router (1) without the latter running the program or that it is still in the process of downloading the program. But as in the previous example, when the packets of the video stream arrive at the router (1), the latter recognises them using the filter already in place. As a result, the router (1) places these packets in a temporary storage queue while waiting for them to be processed by the program. Thus, none of the packets in the stream to be processed is transmitted to terminal 3 without having been actually processed by the router (1).

Even though the early-processing requests in the above-mentioned examples concern the putting in place of a filter for recognition of the packets to be intercepted for processing, they can also concern other processes.

As an example, an early-processing request can concern the dimensioning by the router of a temporary packet storage queue. In other words, such a request specifies the size of this storage queue to be put in place by the active router. A request of this type can, in particular, complete an early-processing request for the putting in place of a filter of the type previously described, for the purpose of ensuring that the queue is of sufficient size to store the packets in the stream to be processed during the time required to download and run the program.

More generally, the early-processing requests can concern any sort of configuration of the putting in place of the processing program. In a first example, the request specifies the number of instances of the processing program to be run in parallel, for the purpose of parallel processing of the packets in the stream to be processed. In a second example, the request specifies the memory size to be allocated to the processing program. In a third example, the request specifies the policy to be applied by the router in the event that the queue storage capacity is exceeded before the program has been able to start.

These examples are obviously not exhaustive, and can be combined together or not.

The requests can also concern the manner in which the active packet itself is recommended to be handled by the active router. As an example, an early-processing request includes an indication used to tell the router (1) whether it can:
send the active packet which contains it to its recipient before the execution of the other early-processing requests contained in this active packet; or
on the contrary, if it should provide for the execution of these other requests before sending the active packet to its recipient; or again,
whether it should provide for loading/downloading of the processing program and its running, before sending the active packet to its recipient.

On receipt of an active packet, the router reads this indication in the active packet, and applies the corresponding order. Optionally, such an indication can form part of the label used to mark the early-processing request in the packet, when the label technique is used as described earlier.

Such an indication results in flexible management of the active packets by the active routers, depending on the imperatives of the processing programs

In particular, it allows the size of the network or the slowing down of the data exchanges to be reduced, by avoiding automatic retention of the active packet up to the running of the early-processing requests, or even up to the complete running of the program. Such an indication can consist, with advantage, in one or more boolean operations at a predetermined position in the options (7) of the active packet.

Furthermore, the early-processing requests can concern processing to be effected by the active router on the active packet itself which contains this request. For example, It can be a process to be executed on the data zone (8)—the payload—of the active packet. In particular, it can be a coding or numbering of the data of the active packet.

Of course, this present invention is not limited to the examples and methods of implementation described and represented here, but can give rise to many variants which are accessible to the professional engineer or programmer. In particular, the invention is applicable more generally to any packet-switched communication network which includes active nodes other than those employing the IP protocol.

1. An operating process for an active node (1) suitable for the processing of data packets by executing a program contained or identified in an active packet, this program being intended to control data packet processing functions, characterised in that it includes the following steps:
a) reception of an active packet;
b) execution of a request contained in the active packet, and intended to configure packet processing functions;
c) execution of a program contained or identified in the active packet, and intended to control data packet processing functions, this program being executed after the execution of this request.

2. A process according to claim 1, characterised in that step b includes the putting in place of a packet filter.

3. A process according to claim 2, characterised in that step b) is followed by a step for the receipt and storage of packets corresponding to the filter, for at least as long as step c has not been implemented.

4. A process according to claim 1, characterised in that said active packet should be sent to an network address, this process including, after step b), a step for sending of the active packet to said address.

5. A process according to claim 1, characterised in that said active packet should be sent to an network address, this process including a step for sending of the active packet to said address either after step b) or after step c), depending on the request contained in the active packet.

6. A process according to claim 1, characterised in that step b includes an operation for the dimensioning of a packet storage queue.

7. A process according to claim 1, characterised in that step b) includes an operation for reading, from the active pocket, the parameters for running the program.

8. A process according to claim 1, characterised in that step c) includes an operation for the downloading of a program identified in the active packet.

9. An active node (1) suitable for the processing of data packets by executing a program contained or identified in an active packet, this program being intended to control data packet processing functions, characterised in that it includes the means for:
a) receipt of an active packet;
b) execution of a request contained in the active packet, and intended to configure packet processing functions;
c) and execution of a program contained or identified in the active packet, and intended to control data packet processing functions, this program being executed after the execution of this request.

10. A data packet, characterised in that it includes:
a request intended to be executed in an active node to configure packet processing functions, before the execution of a program controlling packet processing functions;
and a program or an identifier for a program, this program being intended to be executed at an active node in order to control packet processing functions, after the execution of the request.

11. A data packet according to claim 11, of the IP type, in which said program or said program identifier, and said request, are placed in the options of the IP packet.
